(19) United States
(12) Patent Application Publication
(10) Pub. No.: US 2023/0150578 A1
(43) Pub. Date: May 18, 2023

(54) METHOD AND SYSTEM FOR CORRECTING ANGLE OUTPUT

(71) Applicant: KABUSHIKI KAISHA TOKAI RIKA DENKI SEISAKUSHO, Aichi (JP)

(72) Inventors: Toru KOSHIMIZU, Aichi (JP); Seiji KONDO, Aichi (JP)

(73) Assignee: KABUSHIKI KAISHA TOKAI RIKA DENKI SEISAKUSHO, Aichi (JP)

(21) Appl. No.: 17/984,538

(22) Filed: Nov. 10, 2022

(30) Foreign Application Priority Data
Nov. 16, 2021 (JP) 2021-186392

(51) Int. Cl. B62D 15/02

(52) U.S. Cl. CPC B62D 15/025; B62D 15/021

(57) ABSTRACT

A correction system for a steering device that steers a steered wheel so that a steered angle of the steered wheel follows a steering angle of a steering wheel of a vehicle. The correction system includes a mode setting unit that sets the steering device to a correction mode for correcting the steering angle. An error calculation unit receives the detected steering angle and the detected steered angle in the correction mode when the steering wheel is rotated to calculate the difference between the steering angle and the steered angle and obtain a trigonometric waveform as an error of the steering angle. A correction unit corrects a parameter of the waveform so that the waveform become close to optimal.

### BACKGROUND

### 1. Field

The present disclosure relates to a method and system for correcting angle output.

### 2. Description of Related Art

A steer-by-wire type steering device of a vehicle electrically detects a steered amount of a steering wheel with a sensor and drives the steered wheels accordingly with an actuator (refer to, for example, Japanese Laid-Open Patent Publication No. 2014-221593). Thus, in such a steering device, the steering wheel is not mechanically coupled to the steered wheels. A steer-by-wire type steering device for a vehicle has various advantages. For example, the maneuverability of the steering wheel can be improved, the degree of freedom for control can be increased, and the weight and bulk can be decreased.

### SUMMARY

A typical steer-by-wire type steering device receives a signal from a sensor that detects the steering angle of a steering wheel and a signal from a sensor that detects the steered angle of the steered wheels. The steering device uses these signals to control the steered angle of the steered wheels by driving the actuator so that the steered angle of the steered wheels follows the steering angle of the steering wheel.

In such type of a steering device, the detected steering angle of the steering wheel and the detected steered angle of the steered wheels may include errors caused by wear or the like. In this case, the steered angle of the steered wheels will not correspond to the steered amount of the steering wheel. This may result in the driver feeling awkward when maneuvering the vehicle.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One aspect of the present disclosure is a method for correcting an angle output. The method is employed by a stand-by-wire steering device that steers a steered wheel so that a steered angle of the steered wheel follows a steering angle of a steering wheel of a vehicle based on a first detection value of a steering angle detection unit that detects the steering angle. The method includes setting, by a correction system that corrects an output of the steering angle unit, an operation mode of the steering device to a correction mode for correcting an output, receiving, by the correction system, the first detection value from the steering angle detection unit and a second detection value from a steered angle detection unit that detects the steered angle of the steered wheel when the steering wheel is actually rotated in the correction mode to calculate a difference of the first detection value and the second detection value and obtain an error waveform that is a trigonometric waveform as an error of the first detection value, and correcting, by the correction system, at least one of parameters that are elements of the error waveform to a value that has the error waveform become close to optimal.

A further aspect of the present disclosure is a correction system for a stand-by-wire steering device that steers a steered wheel so that a steered angle of the steered wheel follows a steering angle of a steering wheel of a vehicle based on a first detection value of a steering angle detection unit that detects the steering angle. The correction system includes a mode setting unit that sets an operation mode of the steering device to a correction mode for correcting an output, an error calculation unit that receives the first detection value from the steering angle detection unit and a second detection value from a steered angle detection unit that detects the steered angle of the steered wheel when the steering wheel is actually rotated in the correction mode to calculate a difference of the first detection value and the second detection value and obtain an error waveform that is a trigonometric waveform as an error of the first detection value, and a correction unit that corrects at least one of parameters that are elements of the error waveform to a value that has the error waveform become close to optimal.

Other features and aspects will be apparent from the following detailed description, the drawings, and the claims.

### BRIEF DESCRIPTION OF THE DRAWINGS

FIG. 1 is a diagram showing the configuration of a steer-by-wire type steering device and a correction system.

FIG. 2A is a waveform chart illustrating an erroneous waveform prior to correction.

FIG. 2B is a waveform chart illustrating the erroneous waveform subsequent to correction.

FIG. 3 is a diagram comparing the waveforms of a first detection value and a second detection value prior to correction.

FIG. 4 is a diagram comparing the waveforms of the first detection value and the second detection value subsequent to correction.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art

One embodiment of a method and system for correcting an angle output will now be described.

System Configuration

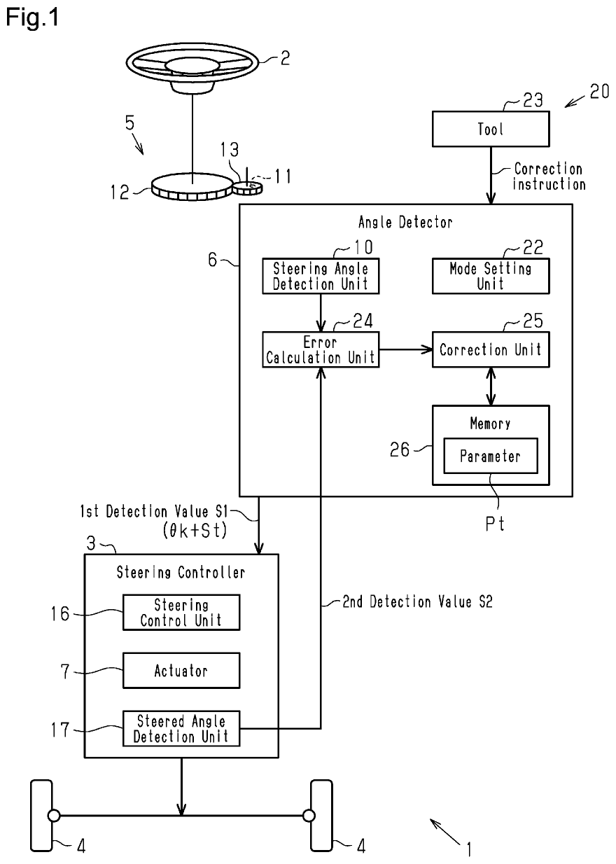

As shown in FIG. 1, a vehicle 1 includes a steer-by-wire type steering device 5 that electrically transmits a steering amount of a steering wheel 2 to a steering controller 3 to control steered wheels 4. In this manner, the steer-by-wire type steering device 5 detects the steering amount of the steering wheel 2 with an angle detector 6 and drives an actuator 7 to electrically steer the steered wheels 4. The steering wheel 2 is not mechanically coupled to the steered wheels 4.

The angle detector 6 includes a set of a steering angle detection unit 10 and a detected portion 11. The angle detector 6 may be, for example, a magnetic sensor that detects the steering amount of the steering wheel 2 from the magnetic intensity that varies as the steering wheel 2 rotates. In this case, the steering angle detection unit 10 may include a Hall IC, and the detected portion 11 may include a magnet. The detected portion 11 may be a sub-gear 13 engaged with a main gear 12 that is rotated integrally with the steering wheel 2.

The steering controller 3 includes a steering control unit 16 that controls the actuator 7 and a steered angle detection unit 17 that detects the steered angle of the steered wheels 4. The steering control unit 16 receives a first detection value S1 from the steering angle detection unit 10 and a second detection value S2 from the steered angle detection unit 17. In one example, the first detection value S1 of the steering angle detection unit 10 is an angle output indicating the steering angle of the steering wheel 2 of the vehicle 1. The first detection value S1 and the second detection value S2 may be, for example, voltage values. The steering control unit 16 uses the first detection value S1 and the second detection value S2 to control the steered angle of the steered wheels 4 by driving the actuator 7 so that the steered angle of the steered wheels 4 follows the steering angle of the steering wheel 2.

Configuration of Correcting System 20

As shown in FIG. 1, the angle detector 6 has a functionality (correcting system 20) for correcting an output of the steering angle detection unit 10 (first detection value S1 prior to correction). The first detection value S1 output from the steering angle detection unit 10 may include an error caused by wear, secular change or the like caused by a long time use after manufacture. Thus, the first detection value S1 may be output as a value in which an error resulting from wear, secular change or the like is added to a true value θk that is set when manufactured. The correcting system 20 of the present example corrects the first detection value S1 so that it becomes closer to the true value θk set when manufactured.

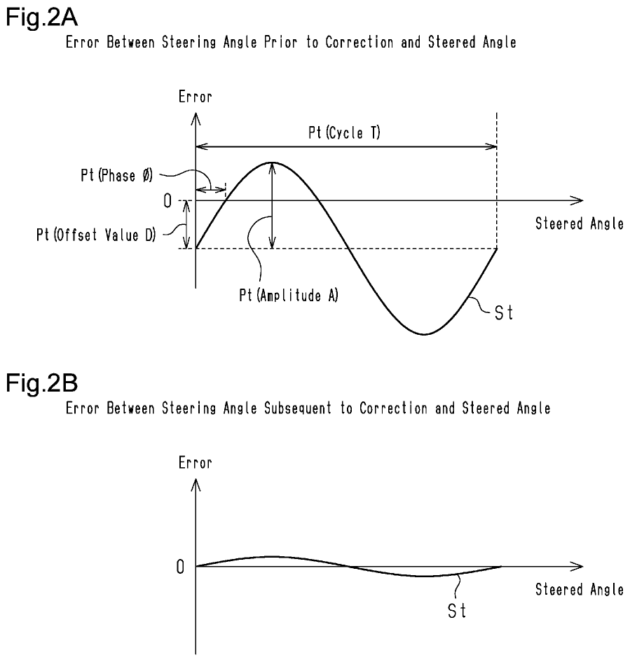

As shown in FIG. 2A, the difference of the first detection value S1, prior to correction, and the second detection value S2 produces an error waveform St that varies in correspondence with a trigonometric waveform as the steering wheel 2 (detected portion 11) rotates. The illustrated error waveform St is a sinusoidal waveform indicating a cyclic tolerance. Thus, the first detection value S1 prior to correction corresponds to a value including an error based on a trigonometric waveform with respect to the true value θk as indicated in equation (1).

S1=θk+(A sin(θk·T+φ))+D (1)

In equation (1), “A” represents the amplitude, “T” represents the cycle, “φ” represents the phase, and “D” represents the offset value. In the present example, the correcting system 20 optimizes at least one of “A”, “T”, “φ”, and “D”, which are parameters Pt of the error waveform St, so that the error waveform St becomes optimal, that is, so that the error waveform St approaches zero.

As shown in FIG. 1, the angle detector 6 includes a mode setting unit 22 that sets an operation mode of the steering device 5 to a correction mode for correcting the output. When receiving a correction instruction from a tool 23 connected to the vehicle 1, the mode setting unit 22 sets the operation mode of the steering device 5 to the correction mode. The correction mode is a mode for correcting the output of the steering angle detection unit 10. When the engine of the vehicle 1 is running, the mode setting unit 22 instructs a technician to intentionally rotate the steering wheel 2 toward the right and toward the rear.

The angle detector 6 includes an error calculation unit 24 that obtains the error waveform St that is a trigonometric waveform included in the first detection value S1 prior to correction. When the technician actually rotates the steering wheel 2 after setting the correction mode, an error calculation unit 24 receives the first detection value S1 from the steering angle detection unit 10 and the second detection value S2 from the steered angle detection unit 17, which detects the steered angle of the steered wheels 4. The error calculation unit 24 calculates the difference of the first detection value S1 and the second detection value S2 to obtain the error waveform St, which is a trigonometric waveform, as the error of the first detection value S1.

The angle detector 6 includes a correction unit 25 that corrects the parameters Pt of the error waveform St to optimal values. The correction unit 25 corrects at least one of the parameters Pt (in present example, “A”, “T”, “φ”, and “D”), which are elements of the error waveform St, to values that allow the error waveform St to become close to optimal. In one example, the correction unit 25 corrects the parameters Pt, which are elements of the error waveform St, to decrease the error of the first detection value S1. In a further example, the correction unit 25 corrects the parameters Pt, which are elements of the error waveform St, to decrease the error between the first detection value S1 and the second detection value S2, or the amplitude of the error waveform St. The correction unit 25 rewrites the parameters Pt, which are stored in a memory 26 of the angle detector 6, to optimized values.

Operation

The operation of the method for correcting the angle output (angle detector 6) in the present embodiment will now be described.

As shown in FIG. 1, when correcting the output of the angle detector 6, a technician connects the tool 23 to the vehicle 1, of which the engine is running, and sends a correction instruction from the tool 23 to the vehicle 1 in order to activate the angle detector 6. Upon receipt of the correction signal from the tool 23, the angle detector 6 sets the operation mode of the steering device 5 to the correction mode. The tool 23 may be a special tool for correcting the output of the angle detector 6 or a personal computer with software installed to correct the output of the angle detector 6.

After sending the correction instruction to the vehicle 1, the tool 23 guides the technician through specific correction tasks. In the present example, for instance, the tool 23 instructs the technician to rotate the steering wheel 2 of the vehicle 1 in one direction (e.g., rightward) to a terminal end of rotation. The guide may be, for example, shown on a screen of the tool 23 or be generated by an on-board device. The on-board device that guides the technician may be, for example, the screen of a car navigation device, a multi-information display, or an on-board speaker.

When the technician rotates the steering wheel 2 in one direction from the neutral position to the corresponding terminal end of rotation, the error calculation unit 24 is provided with the first detection value S1, prior to correction, from the steering angle detection unit 10 and the second detection value S2 from the steered angle detection unit 17. More specifically, the steering angle detection unit 10 provides the error calculation unit 24 with the first detection value S1 that corresponds to the steering angle of the steering wheel 2 intentionally rotated during a correction task. Further, the steered angle detection unit 17 provides the error calculation unit 24 with the second detection value S2 that corresponds to the steered angle of the steered wheels 4 steered by the steer-by-wire steering device 5 during a correction task.

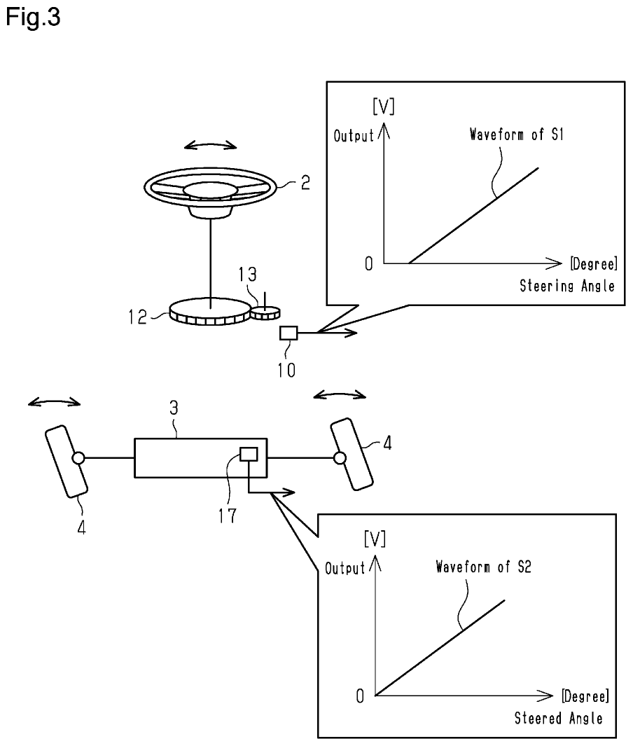

FIG. 3 shows a varied waveform of the first detection value S1 of the steering angle detection unit 10 prior to the correction of the output of the angle detector 6, and a waveform of the second detection value S2 of the steered angle detection unit 17. As apparent from the drawing, an error may be produced between the first detection value S1 and the second detection value S2 due to wear or the like.

As shown in FIG. 2A, the error between the first detection value S1 and the second detection value S2 produces the error waveform St, which varies in correspondence with a trigonometric waveform (sinusoidal waveform in FIG. 2A), when the steering wheel 2 rotates. The error between the first detection value S1 and the second detection value S2 is the component of “(A sin(θk·T+φ))+D” in equation (1), which is described above.

In the present example, as shown in FIG. 2B, the correction unit 25 obtains the parameters Pt so that the error waveform St becomes zero or close to zero. More specifically, the correction unit 25 calculates each of the parameters Pt so that the error waveform St becomes close to a linear waveform, in which the error is zero or substantially zero, rather than a trigonometric waveform. After calculating the parameters Pt, the correction unit 25 overwrites the parameters Pt in the memory 26.

After the output correction in the case where the steering wheel 2 is rotated in one direction (e.g., right direction) is completed, the correcting system 20 performs output correction in the case where the steering wheel 2 is rotated in the other direction (e.g., left direction) in the same manner. When correction of the first detection value S1 is completed for both of the right and left rotation of the steering wheel 2, the correcting system 20 ends the correction task.

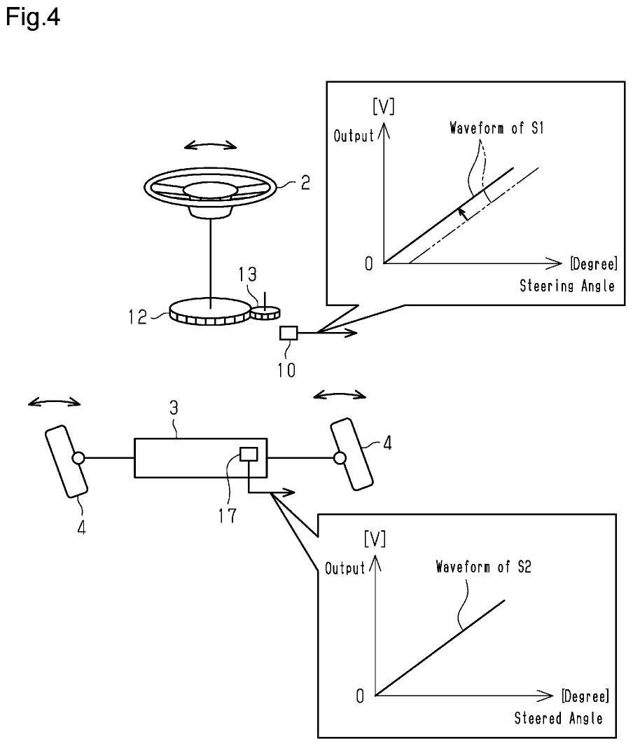

As shown in FIG. 4, when the angle detector 6 actually detects the angle of the steering wheel 2, the first detection value S1 is corrected with the parameters Pt, which are written to the memory 26, and then sent to the steering controller 3. As shown in the same drawing, the first detection value S1 reflecting the new parameters Pt substantially matches the second detection value S2 of the steered angle detection unit 17. Thus, when the steering controller 3 uses the first detection value S1 and the second detection value S2 to steer the steered wheels 4, deviation of the steered angle of the steered wheels 4 from the corresponding steering amount of the steering wheel 2 will be small.

Advantages

The method for correcting the angle output (correcting system 20) in the above embodiment has the advantages described below.

(1) The method for correcting the angle output is used by the steer-by-wire steering device 5 that steers the steered wheels 4 based on the first detection value S1 of the steering angle detection unit 10 that detects the steering angle of the steering wheel 2 of the vehicle 1 so that the steered angle of the steered wheels 4 follows the steering angle of the steering wheel 2. The method for correcting the angle output has the correcting system 20, which corrects the angle output of the steering angle detection unit 10, perform the processes described below.

Setting the operation mode of the steering device 5 in the correction mode for correcting the output.

When the technician actually rotates the steering wheel 2 in the correction mode, receiving the first detection value S1 from the steering angle detection unit 10, receiving the second detection value S2 from the steered angle detection unit 17 that detects the steered angle of the steered wheels 4, and calculating the difference of the first detection value S1 and the second detection value S2 to obtain the error waveform St, which is a trigonometric waveform, as the error of the first detection value S1.

Correcting at least one of the parameters Pt, which are the elements of the error waveform St, to values that allow the error waveform St to become close to optimal.

With this configuration, when correcting the output of the steering angle detection unit 10, the operation mode of the steering device 5 is switched to the correction mode, and the steering wheel 2 is intentionally rotated to receive the first detection value S1 from the steering angle detection unit 10 and the second detection value S2 from the steered angle detection unit 17. Then, the difference of the first detection value S1 and the second detection value S2 is calculated to obtain the error waveform St, which is a trigonometric waveform, as the error of the first detection value S1. Further, at least one of the parameters Pt, which are the elements of the error waveform St, is corrected to a value that allows the error waveform St to become close to optimal. This returns the first detection value S1 of the steering angle detection unit 10 to the optimal value set when manufactured or a value close to the optimal value. Thus, the driver will not feel awkward when turning the steering wheel to maneuver the stand-by-wire type vehicle 1.

(2) The parameters Pt include at least one of the amplitude A, the cycle T, the phase φ, and the offset value D of a trigonometric waveform. This configuration corrects the parameters Pt, which mainly cause errors in the output of the steering angle detection unit 10 and allows the output of the steering angle detection unit 10 to become close to the optimal value.

(3) The task for correcting the output of the steering angle detection unit 10 is performed when the vehicle 1 has been marketed after the angle detector 6, which includes the steering angle detection unit 10, is installed in the vehicle 1 during manufacture. Thus, when the vehicle 1 is used for a long time after manufacture, an error in the output of the steering angle detection unit 10 resulting from wear or the like can be corrected. After manufacture of the vehicle 1, the stand-by-wire type steering device 5 can be maneuvered with the same feel over a long period.

(4) The steering device 5 sets the operation mode to the correction mode when receiving a correction instruction from the connected tool 23. The tool 23 facilitates correction of the output of the steering angle detection unit 10.

### Further Examples

The present embodiment may be modified as described below. The present embodiment and the following modifications can be combined as long as there is no technical contradiction.

The steering angle detection unit 10 and the steered angle detection unit 17 are not limited to magnetic sensors and may be sensors of other types such as optical sensors.

The parameters Pt do not have to be calculated by the angle detector 6 and may be calculated by, for example, the tool 23.

The correction tasks do not have to performed with the tool 23 and may be performed with, for example, an onboard device, such as a car navigation device or a special switch.

The operation mode does not have to be set to the correction mode by the tool 23 and may be set by an on-board device.

The parameters Pt may include values other than those illustrated in the above embodiment such as the inclination of the error waveform St.

The correction task may be performed when the vehicle 1 is manufactured.

During the correction task, the technician can rotate the steering wheel 2 after checking that the steering wheel 2 is located at the neutral position.

The correcting system 20 does not have to be included in the tool 23 and may be configured by only the angle detector 6.

The vehicle 1 is not limited to an automobile and may be, for example, an industrial vehicle such as a forklift.

The mode setting unit 22, the error calculation unit 24, and the correction unit 25 may each be implemented by 1) one or more processors that run on computer programs (software) or 2) a combination of such processors and one or more dedicated hardware circuits such as application-specific integrated circuits (ASICs) that execute at least some of various types of processes. The processors include a CPU and a memory such as a RAM and a ROM, and the memory stores program codes or instructions configured to have the CPU execute processes. The memory, namely, a computer readable medium, includes any available medium that is accessible by a versatile or dedicated computer. Instead of a computer including the above processors, processing circuitry including one or more dedicated hardware circuits may be used to execute the processes described above.

The mode setting unit 22, the error calculation unit 24, and the correction unit 25 may each be implemented by an independent processor. Alternatively, a common processor may be configured to provide some of these functionalities. In this manner, the mode setting unit 22, the error calculation unit 24, and the correction unit 25 do not have to be implemented in functional blocks and may be implemented by partially sharing a common functional block.

The present disclosure is illustrated through the embodiment. However, the present disclosure is not limited to the structure of the embodiment. The present disclosure includes various modified examples and modifications within the scope of equivalence. Additionally, various combinations and modes and one, more, or less of these elements in other combinations and forms are included in the range and conceptual scope of the present disclosure.

Technical concepts that can be understood from each of the above embodiments and modified examples will now be described.

### Embodiment 1

A correcting method for a stand-by-wire steering device (5) that steers a steered wheel (4) so that a steered angle of the steered wheel follows a steering angle of a steering wheel (2) of a vehicle (1) based on a first detection value indicating the steering angle, the method comprising:

setting an operation mode of the steering device to a correction mode for correcting an output;

receiving the first detection value of the steering angle of the steering wheel and a second detection value indicating the steered angle of the steered wheel when the steering wheel is actually rotated in the correction mode to calculate a difference of the first detection value and the second detection value and obtain an error waveform that is a trigonometric waveform as an error of the first detection value; and

correcting at least one of parameters that are elements of the error waveform to a value that has the error waveform decrease an error in the first detection value.

### Embodiment 2

A correction system for a stand-by-wire steering device (5) that steers a steered wheel (4) so that a steered angle of the steered wheel follows a steering angle of a steering wheel (2) of a vehicle (1) based on a first detection value indicating the steering angle, the correction system comprising:

one or more processors; and

one or more memories storing instructions that are executable by the one or more processors, wherein:

execution of the instructions by the one or more processors causes the one or more processors to perform actions;

the actions include
setting an operation mode of the steering device to a correction mode for correcting an output,
receiving the first detection value of the steering angle of the steering wheel and a second detection value indicating the steered angle of the steered wheel when the steering wheel is actually rotated in the correction mode to calculate a difference of the first detection value and the second detection value and obtain an error waveform that is a trigonometric waveform as an error of the first detection value, and
correcting at least one of parameters that are elements of the error waveform to decrease an error in the first detection value.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A method for correcting an angle output, the method being employed by a stand-by-wire steering device that steers a steered wheel so that a steered angle of the steered wheel follows a steering angle of a steering wheel of a vehicle based on a first detection value of a steering angle detection unit that detects the steering angle, the method comprising:
setting, by a correction system that corrects an output of the steering angle unit, an operation mode of the steering device to a correction mode for correcting an output;
receiving, by the correction system, the first detection value from the steering angle detection unit and a second detection value from a steered angle detection unit that detects the steered angle of the steered wheel when the steering wheel is actually rotated in the correction mode to calculate a difference of the first detection value and the second detection value and obtain an error waveform that is a trigonometric waveform as an error of the first detection value; and
correcting, by the correction system, at least one of parameters that are elements of the error waveform to a value that has the error waveform become close to optimal.

2. The method according to claim 1, wherein the parameters include at least one of amplitude, cycle, phase, and offset value of a trigonometric waveform.

3. The method according to claim 1, wherein a task for correcting an output of the steering angle detection unit is performed when the vehicle has been marketed after an angle detector including the steering angle detection unit is installed in the vehicle during manufacture.

4. The method according to claim 1, wherein the steering device sets the operation mode to the correction mode when a correction instruction is received from a tool connected to the steering device.

5. A correction system for a stand-by-wire steering device that steers a steered wheel so that a steered angle of the steered wheel follows a steering angle of a steering wheel of a vehicle based on a first detection value of a steering angle detection unit that detects the steering angle, the correction system comprising:
a mode setting unit that sets an operation mode of the steering device to a correction mode for correcting an output;
an error calculation unit that receives the first detection value from the steering angle detection unit and a second detection value from a steered angle detection unit that detects the steered angle of the steered wheel when the steering wheel is actually rotated in the correction mode to calculate a difference of the first detection value and the second detection value and obtain an error waveform that is a trigonometric waveform as an error of the first detection value; and
a correction unit that corrects at least one of parameters that are elements of the error waveform to a value that has the error waveform become close to optimal.
